(19) United States
(12) Patent Application Publication
(10) Pub. No.: US 2003/0019288 A1
(43) Pub. Date: Jan. 30, 2003

(54) Airtight sealed sensor

(76) Inventor: Uwe Konzelmann, Asperg (DE)

Correspondence Address: KENYON & KENYON, ONE BROADWAY, NEW YORK, NY, 10004, US

(21) Appl. No.: 10/088,845

(22) PCT Filed: Jul. 20, 2001
(86) PCT No.: PCT/DE01/02660

(30) Foreign Application Priority Data
Jul. 21, 2000 (DE) 100 35 538.2

(51) Int. Cl. G01F 1/68

(52) U.S. Cl. 73/204.22

(57) ABSTRACT

In a sensor according to the related art, specifically for a device for determining at least one parameter of a medium flowing in a supply line, the sensor having a frame element that has a recess, undercurrents occur in the area of the recess. This results in the measuring signal of the sensor being influenced.

In a sensor (1) configured in accordance with the present invention, the recess (5) is enclosed, so that undercurrents no longer occur.

### BACKGROUND INFORMATION

The present invention relates to a sensor of the species of claim 1.

From German Patent 196 01 791 A1, a sensor is known having a frame element and a membrane, the frame element having a recess. However, this recess is not enclosed, so that, due to undesirable air currents in the recess, heat transmission occurs as a result of heat being conducted to the membrane, thus distorting the measuring signal of a measuring element.

From German Patent 195 24 634 A1, a sensor is known that is embedded in a measuring device. In this context, undesirable sensor undercurrents arise. In order to prevent this, the attempt is made to install a seal between the sensor and a sensor carrier. This is done, for example, using an adhesive agent, which nevertheless can flow and influence the measuring characteristics of the sensor.

From U.S. Pat. No. 4,934,190, a sensor is known in which a sensor is closed in an airtight manner. However, the sensor does not have a membrane. It is also not shown how the sensor is embedded in a device.

### ADVANTAGES OF INVENTION

In contrast, the sensor according to the present invention having the characterizing features of claim 1 has the advantage that sensor undercurrents are prevented in a simple manner.

As a result of the measures indicated in the dependent claims, advantageous refinements and improvements of the sensor cited in claim 1 are possible.

It is advantageous if a recess of the sensor is covered by a supporting body or by a sensor carrier.

In this context, it is advantageous to evacuate the closed volume at least partially.

It is particularly advantageous that the supporting body or the sensor carrier be configured so that a membrane, when bent, cannot break.

It is also advantageous if the frame element and the supporting body are manufactured in one piece.

### DRAWING

Exemplary embodiments of the present invention are depicted in simplified form in the drawing and are discussed in greater detail in the description below.

FIG. 1 depicts a sensor according to the related art,

FIGS. 2, 3, and 4 depict a first, second, and third exemplary embodiment of the sensor configured according to the present invention.

### DESCRIPTION OF THE EXEMPLARY EMBODIMENTS

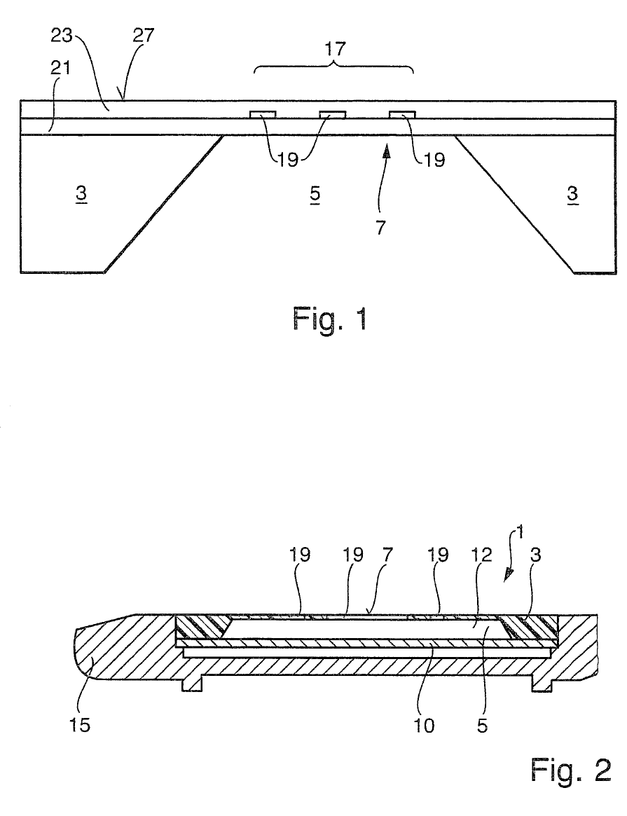

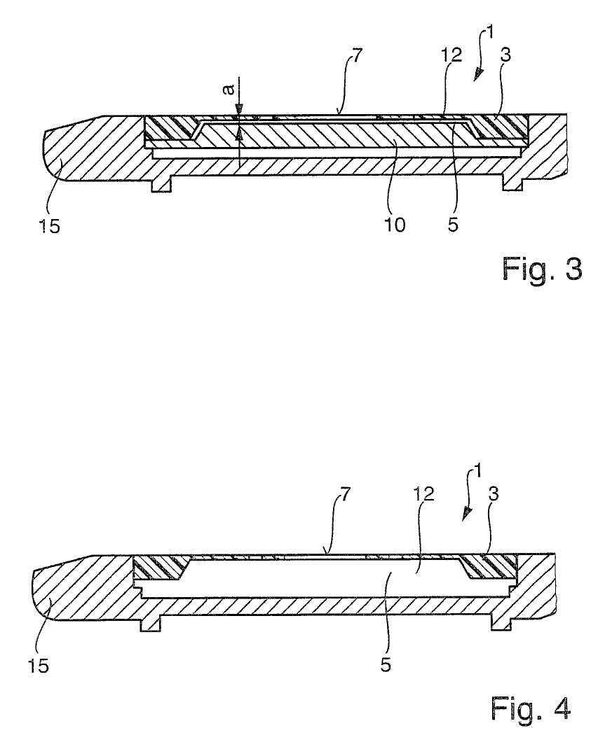

FIG. 1 depicts a sensor according to the related art, which is improved in accordance with the designs indicated in FIGS. 2 through 4. A sensor of this type and an exemplary method for manufacturing it are known, for example, from German Patent 196 01 791 A1 and are meant to be an integral part of this disclosure. The sensor has a frame element 3, which is made, for example, of silicon. Frame element 3 has a recess 5. Arranged on the frame element is a dielectric layer 21, for example, made of SiO₂. Layer 21 can extend over entire frame element 3, or only over one area of recess 5. This area constitutes a membrane 7, which borders recess 5 on one side partially or entirely. Arranged on the side of membrane 7 facing away from recess 5 are at least one, and, for example, three metal circuit traces 19. Metal circuit traces 19 form, for example, electrical heating elements and/or measuring resistors. Metal circuit traces 19 along with membrane 7 form a sensor area 17. Sensor area 17 is preferably covered by a protective layer 23. Protective layer 23 may also extend only over metal circuit traces 19. Sensor 1 has a surface 27, which is in direct contact with the flowing medium.

FIG. 2 depicts a first exemplary embodiment of a sensor 1 configured in accordance with the present invention. A sensor 1 is composed of frame element 3, which has recess 5. Configured on the exterior side of frame element 3 facing away from recess 5 is membrane 7. Recess 5 is enclosed in an airtight manner by a supporting body 10. As a result, heat transmission is prevented that comes about as a result of thermal conduction occurring due to an undercurrent of sensor 1 from a flowing medium. In order to further reduce the thermal conduction in closed recess 5, an interstitial space 12, that is formed by the closed recess 5, can be evacuated at least partially. Supporting body 10 can be joined in different ways to frame element 3, for example, using an adhesive agent, or by welding. Sensor 1 is arranged, for example, in a sensor carrier 15, which is embedded in a measuring device or is part of a measuring device.

FIG. 3 depicts a further exemplary embodiment of sensor 1 configured in accordance with the present invention. As a result of pressure fluctuations in the flowing medium, for example, due to pulsations, membrane 7 can bend and, in the process, break. This can be prevented as a result of the fact that distance a between the lower side of the membrane and supporting body 10 is reduced so that membrane 7, in response to a predetermined degree of bending, comes into contact with supporting body 10. In this manner, further bending of membrane 7 is prevented, such as otherwise could lead to breaking or damaging membrane 7.

Heat transmission due to thermal conduction and potentially due to uncontrolled air currents caused by convection beneath the membrane is prevented by enclosing the lower side of the membrane using supporting body 10. In this manner, a more stable and more reproducible measuring signal of the sensor is generated. In addition, thermal currents are reduced that are caused by the uncontrolled air currents beneath the lower side of the membrane and are able to influence the measuring signal.

Supporting body 10 and frame element 3 can also be executed, for example, as one piece. This is possible, e.g., using methods of surface micromechanics.

FIG. 4 depicts a third exemplary embodiment of sensor 1 configured in accordance with the present invention. In this exemplary embodiment, recess 5 is enclosed by sensor carrier 15. This space, closed off in this manner, can also be evacuated, or sensor carrier 15 can be configured in accordance with FIG. 3, so that excessive bending of the membrane is prevented.

Frame element 3 can be joined in various ways to sensor carrier 15, e.g., using an adhesive agent, or by welding. In addition, sensor 1 can be extrusion-coated in an airtight manner using plastic, or it can be stamped into malleable plastic, if sensor carrier 15 is made of plastic.

As the material for sensor carrier 15, it is preferable to use plastic or metal, and to make frame element 3 and supporting body 10 of silicon.

A sensor 1 of this type is particularly well suited as an air-mass sensor.

What is claimed is:

1. A sensor (1), specifically for a device for determining at least one parameter of a medium flowing in a supply line, having of a frame element (3), which forms a recess (5), and which is at least partially bounded on one side by a membrane (7), wherein the recess (5) is enclosed in an airtight manner on the side opposite the membrane.

2. The sensor as recited in claim 1,
wherein a supporting body (10) contacts the frame element (3) and, as a result, encloses the recess (5).

3. The sensor as recited in claim 2,
wherein an interstitial space (12) between the supporting body (10) and the frame element (3) is at least partially evacuated.

4. The sensor as recited in claim 1,
wherein the sensor (1) is arranged in a sensor carrier (15), and the sensor carrier (15) contacts the frame element (3) and, as a result, encloses the recess (5).

5. Sensor as recited in claim 4,
wherein an interstitial space (12) between the sensor carrier (15) and the frame element (3) is at least partially evacuated.

6. The sensor as recited in claim 1 or 4,
wherein the sensor (1) has a sensor area (17), which has at least one metallic printed circuit trace (19), which is arranged on a dielectric (21), which is arranged on the frame element (3).

7. The sensor as recited in one or more of claims 1, 4, or 6,
wherein one surface (27) of the sensor (1) is configured in a planar fashion.

8. The sensor as recited in one or more of claims 1, 6, or 7,
wherein the sensor (1) has a supporting body (10),
the sensor has a flexible membrane (7), and
a distance between the membrane (7) and the supporting body (10) is such that the membrane (7), when bent, contacts the supporting body (10) at least partially.

9. The sensor as recited in one or more of claims 1, 4, 6, or 7,
wherein the sensor (1) is arranged in a sensor carrier (15),
the sensor (1) has a flexible membrane (7), and
a distance between the membrane (7) and the sensor carrier (15) is such that the membrane (7), when bent, contacts the sensor carrier (15) at least partially.

10. The sensor as recited in claim 2 or 3,
wherein the frame element (3) and the supporting body (10) are manufactured in one piece.

11. The sensor as recited in claim 4 or 9,
wherein the sensor carrier (15) is made of plastic.

12. The sensor as recited in claim 4 or 9,
wherein the sensor carrier (15) is made of metal.

13. The sensor as recited in one or more of claims 2 through 5, or 10,
wherein the frame element (3) is made of silicon or doped silicon.

14. The sensor as recited in one or more of claims 1, 4, 6, or 7,
wherein the sensor (1) is arranged in a sensor carrier (15).
